(19) United States
(12) Patent Application Publication
(10) Pub. No.: US 2018/0047387 A1
(43) Pub. Date: Feb. 15, 2018

(54) SYSTEM AND METHOD FOR GENERATING ACCURATE SPEECH TRANSCRIPTION FROM NATURAL SPEECH AUDIO SIGNALS

(71) Applicants: Igal NIR, Lehavim (IL); VOCASEE TECHNOLOGIES LTD., Beer Sheva (IL)

(72) Inventor: Igal NIR, Lehavim (IL)

(21) Appl. No.: 15/555,731

(22) PCT Filed: Mar. 3, 2016
(86) PCT No.: PCT/IL2016/050246

§ 371 Date: Sep. 5, 2017

Related U.S. Application Data
(60) Provisional application No. 62/128,548, filed on Mar. 5, 2015.

(51) Int. Cl. G10L 15/08; G10L 15/05; G10L 15/07; G06F 17/18; G06F 17/30; G10L 15/02; G10L 15/06

(52) U.S. Cl. CPC G10L 15/08; G10L 15/02; G10L 15/05; G10L 15/063; G06F 17/18; G06F 17/3074; G10L 15/07; G10L 15/32

(57) ABSTRACT

Apparatus for generating accurate speech transcription from natural speech, comprising a data storage for storing a plurality of audio data items, each of which being recitation of text by a specific speaker! a plurality of ASR modules, each of which being trained to optimally create a unique acoustic/linguistic model according to the spectral components contained in said audio data item and analyzing each audio data item and representing said audio data item by an ASR module! a memory for storing all unique acoustic/linguistic models! a controller, adapted to receive natural speech audio signals and divide each natural speech audio signal to equal segments of a predetermined time! adjust the length of each segment, such that each segment will contain one or more complete words! distribute said segments to all ASR module and activate each ASR module to generate a transcription of the words in each segment according to the level of matching to its unique acoustic/linguistic model! calculate, for each given word in a segment, a confidence measure being the probability that said given word is correct; for each segment and for each ASR module, calculate the average confidence of the transcription; obtain the confidence for each word in the segment and calculating mean confidence value of said word! for each segment, decide which transcription is the most accurate by choose only the ASR module with the highest average confidence, from all chosen ASR modules for said segment and creating the transcription of said audio signal by combining all transcriptions resulting from the decisions made for each segment.

### FIELD OF THE INVENTION

The present invention relates to the field of speech recognition. More particularly, the invention relates to a method and system for generating accurate speech transcription from natural speech audio signals.

### BACKGROUND OF THE INVENTION

Subtitling and closed captioning are both processes of displaying text on a television, video screen, or other visual display to provide additional or interpretive information. Closed captions typically show a transcription of the audio portion of a program as it occurs. However, these processes should be able to obtain an accurate transcription of the audio portion and often use Automated Speech Recognition techniques for obtaining transcription.

WO 2014/155377 discloses a video subtitling system (hardware device) for automatically adding subtitles in a destination language. The device comprises a CPU for processing a stream of separate audio and video signals which are received from the audio-visual source and are subdivided into a plurality of predefined time slices; an audio buffer for temporarily storing time slices of the received audio signals which are representative of one or more words to be processed by the CPU; a speech recognition module for converting the outputted audio signals to text in the source language; a text to subtitle module for converting the text to subtitles by generating an image containing one or more subtitle frames; an input video buffer for temporarily storing each time slice of the received video signals for a sufficient time needed to generate one or more subtitle frames and to merge the generated one or more subtitle frames with the time slice of video signals; an output video buffer for receiving video signals outputted by the input video buffer concurrently to transmission of additional video signals of the stream to the input video buffer, in response to flow of the outputted video signals to the output video buffer; a layout builder for merging one or more of the subtitle frames with a corresponding image frame to generate a composite frame; and a synchronization module for synchronizing between each group of composite frames and their corresponding time slices of a sound track associated with the audio signal before outputting the synchronized composite frame group and audio channel to the video display.

One of the critical components of such a system is the speech recognition module, which should accurately convert the outputted audio signals to text in the source language.

One of the existing speech recognition modules is an Automatic Speech Recognition (ASR) module, which is based on a software solution that converts spoken audio into text, to provide users with a more efficient means of input. A Speech Recognition module compares spoken input to a list of phrases to be recognized, called a grammar. The grammar is used to constrain the search, thereby enabling the ASR module to return the text that represents the best match. This text is then used to drive the next steps of speech-enabled application. However, automated speech recognition solutions still suffer from problems of insufficient accuracy.

Conventional technologies for improving the required accuracy use machine learning techniques, such as training a software module to be able to identify spoken words and output a corresponding transcription by inputting predetermined audio content (of a training speaker) along with its exact predetermined transcription. At the end of the training stage, the trained software module creates a speech model that should be able to analyze unknown audio content (of an unknown speaker) and extract a transcription, where a higher level of similarity between the training speaker and the unknown speaker yields a more accurate transcription. However, this solutions still suffers from insufficient accuracy since many times the voice of a speaker varies during speaking. Moreover, there are cases where there are several speakers (such as during a meeting) that speak one after the other during the same session and therefore, the acoustic/linguistic model used by the trained software module cannot be optimized to all speakers, who have different acoustic/linguistic models.

It is therefore an object of the present invention to provide a system for generating speech transcription from natural speech audio signals, with high level of accuracy.

It is another object of the present invention to provide a system for generating speech transcription from natural speech audio signals, which optimizes the required computational resources.

Other objects and advantages of the invention will become apparent as the description proceeds.

### SUMMARY OF THE INVENTION

The present invention is directed to a method for generating accurate speech transcription from natural speech, which comprises the following steps:
a) storing in a database, a plurality of audio data items, each of which being recitation of text by a specific speaker;
b) analyzing each audio data item and representing the audio data item by an ASR module, being trained to optimally create a unique acoustic/linguistic model according to the spectral components contained in the audio data item;
c) storing all unique acoustic/linguistic models;
d) receiving natural speech audio signals and dividing each natural speech audio signal to equal segments of a predetermined time (e.g., 0.5 to 10 Sec);
e) adjusting the length of each segment, such that each segment will contain one or more complete words;
f) distributing the segments to all ASR module and allowing each ASR module to:
   f.1) generate a transcription of the words in each segment according to the level of matching to its unique acoustic/linguistic model;
   f.2) calculate, for each given word in a segment, a confidence measure being the probability that the given word is correct;
g) for each segment and for each ASR module, calculating the average confidence of the transcription;
h) obtaining the confidence for each word in the segment and calculating mean confidence value of the word;
i) for each segment, deciding which is the most accurate transcription by performing the following steps:
j) from all chosen ASR modules for the segment, choosing only the ASR module with the highest average confidence; and
k) creating the transcription of the audio signal by combining all transcriptions resulting from the decisions made for each segment.

Whenever there are more than one ASR modules with same average confidence, the ASR module that gave as a result containing more words is chosen. If still there is more than one chosen ASR module, the one with the minimal standard deviation of the confidence of the words in the segment is chosen.

Training may be performed according to the following steps:
a) creating N (N≧1) ASR modules of N selected different training speakers (in the order of several dozens or hundreds); and
b) training each ASR module by an ASR module being an individual ASR module, with speech audio data of a specific training speaker and its corresponding known textual data.

The transcription may be created according to the following steps:
a) receiving an audio or video file that contains speech;
b) dividing the speech audio data to segments according to attributes of the speech audio data; and
c) whenever a word is divided between two segments, checking the location of the majority of the audio data that corresponds to the divided word and modifying the segmentation such that the entire word will be in the containing the majority;
d) whenever a single processor is used, distributing each received audio segment between all N ASR modules, to one ASR module at a time;
e) whenever the received audio segment comprises audio data of several speakers, performing segmentation into shorter segments and matching the most adequate ASR module for each shorter segment;
f) retrieving the outputs of all N ASR modules in parallel; and
g) selecting and return the optimal transcription among the outputs.

The most adequate ASR module may be matched for each shorter segment by the following steps:
a) for each word, allowing each ASR module of an ASR module to return a confidence measure representing the probability that the given word is correct;
b) calculate the average confidence of the transcription for each segment and for each ASR module by receiving the confidence measure for each word in the segment and calculating mean confidence value of the words over all N ASR modules;
c) for each segment, decide which transcription is the most accurate by choosing only the ASR modules that gave transcription for which number of words is equal to the maximum number of words in a segment, or smaller than the maximum number of words by 1;
d) from all ASR modules chosen in the preceding step for the segment, choosing only the ASR module whose average confidence is higher;
e) if there are two or more ASR modules with same average confidence, choosing the ASR module that gave a result containing more words;
f) if still there are two or more chosen ASR modules, choosing the ASR module with the minimal Standard Deviation (STD) of the confidence of words in the segment; and
g) obtaining the most accurate transcription by combining all the decisions made for each segment.

The transcription of a segment may be started with the ASR module that has been selected for its preceding segment. Ongoing histograms of the selected ASR modules may be stored for saving computational resources.

The transcription of a segment may be started with the ASR module being at the top in the histogram of the ASR modules selected so far and if the average confidence obtained is still below a predetermined threshold, continuing to the next level below the top and so forth.

The speech audio data used for training each ASR module may be retrieved from one or more of the following sources:
Commercially available or academic databases that include a plurality of speech recordings and their corresponding transcription;
Studio made recordings of training speakers, each of which reading a pre-prepared text;
A database that aggregates and stores audio files of users of mobile devices that read predetermined text.

N may represent a variety of speech styles that are characterized by:
The gender of a training speaker;
The age of a training speaker;
The accent of a training speaker.

Multiple processors may be activated using a cloud based computational system.

The present invention is also directed to an apparatus for generating accurate speech transcription from natural speech, which comprises:
a) a data storage for storing a plurality of audio data items, each of which being recitation of text by a specific speaker;
b) a plurality of ASR modules, each of which being trained to optimally create a unique acoustic/linguistic model according to the spectral components contained in the audio data item and analyzing each audio data item and representing the audio data item by an ASR module;
c) a memory for storing all unique acoustic/linguistic models;
d) a controller, adapted to:
   d.1) receive natural speech audio signals and divide each natural speech audio signal to equal segments of a predetermined time;
   d.2) adjust the length of each segment, such that each segment will contain one or more complete words;
   d.3) distribute the segments to all ASR module and activate each ASR module to:
      generate a transcription of the words in each segment according to the level of matching to its unique acoustic/linguistic model; calculate, for each given word in a segment, a confidence measure being the probability that the given word is correct;
   d.4) for each segment and for each ASR module, calculate the average confidence of the transcription;
   d.5) obtain the confidence for each word in the segment and calculating mean confidence value of the word;
   d.6) for each segment, decide which transcription is the most accurate by performing the following steps:
   d.7) from all chosen ASR modules for the segment, choose only the ASR module with the highest average confidence; and
   d.8) create the transcription of the audio signal by combining all transcriptions resulting from the decisions made for each segment.

The ASR modules may be implemented using a computational cloud, such that each ASR module is run by a different computer among the resources of the cloud or alternatively, by using a computational cloud, such that each ASR module is run by a different computer among the resources of the cloud.

The apparatus may comprise:
a) a dedicated computational device with N hardware cards mounted together, each card implementing an ASR module that includes a CPU and a memory implemented in an architecture that is optimized for speech signal processing; and
b) a controller for controlling the operation of each hardware card by distributing the speech signal to each one and collecting the segmented transcription results from each one. Each memory is configured to optimally and rapidly submitting/reading data to/from the CPU.

### BRIEF DESCRIPTION OF THE DRAWINGS

In the drawings:

FIG. 1 illustrates the process of training ASR modules the system, according to an embodiment of the invention;

FIGS. 2a-2b illustrate the process of eliminating cutting of a word into two parts during speech segmentation, according to an embodiment of the invention;

FIG. 3 illustrates the process of generating a transcription of the words in an audio segment, according to an embodiment of the invention;

FIG. 4 illustrates the process of obtaining the optimal transcription, according to an embodiment of the invention; and

FIG. 5 shows a possible hardware implementation of the system for generating accurate speech transcription, according to an embodiment of the invention.

### DETAILED DESCRIPTION OF PREFERRED EMBODIMENTS

The present invention describes a method and system for generating accurate speech transcription from natural speech audio data (signals). The proposed system employs two processing stages: the first stage is a training stage, during which a plurality of ASR modules are trained to analyze speech audio signals, to create speech model and provide a corresponding transcription of selected speakers who recite a known predetermined text. The second stage is a transcription stage, during which the system receives speech audio data of new speakers (who may, or may not part of the training stage) and uses the acoustic/linguistic models obtained from the training stage to analyze the received speech audio data and extract an optimal corresponding transcription.

### Training Stage:

During the training stage, the proposed system will contain an ASR module such as Sphinx (developed at Carnegie Mellon University and include a series of speech recognizers and an acoustic module trainer), Kaldi (an open-source toolkit for speech recognition, to provide a flexible code that is easy to understand, modify and extend), Dragon (a speech recognition software package developed by Nuance Communications, Inc. Burlington, Mass. The user is able to dictate and have speech transcribed as written text or issue commands that are recognized as such by the program).

The system proposed by the present invention is adapted to train N (N≧1) ASR modules, each of which representing a speaker) modules of N selected different speakers, such that a higher N yields higher accuracy. Typical values of N required for obtaining desired accuracy may be in the order of several dozens or hundreds.

Each ASR module will be created by an ASR module (i.e., an individual ASR module) that will be trained with speech audio data of a specific speaker and their corresponding (and known) textual data. The speech audio data that will be used for training each ASR module can be retrieved by one or more sources, such as:
Commercially available or academic databases (DBs) that include a plurality of speech recordings and their corresponding transcription;
Studio made recordings of people, each of which reading a pre-prepared text;
A cloud DB that aggregates and stores audio files of users of mobile devices (e.g., smartphones) that read predetermined text, so their speech signal with the corresponding text will be stored in the cloud DB;
Any other data collection method, which is adapted to generate a bank speech signals of recited predetermined text, along with the corresponding text.

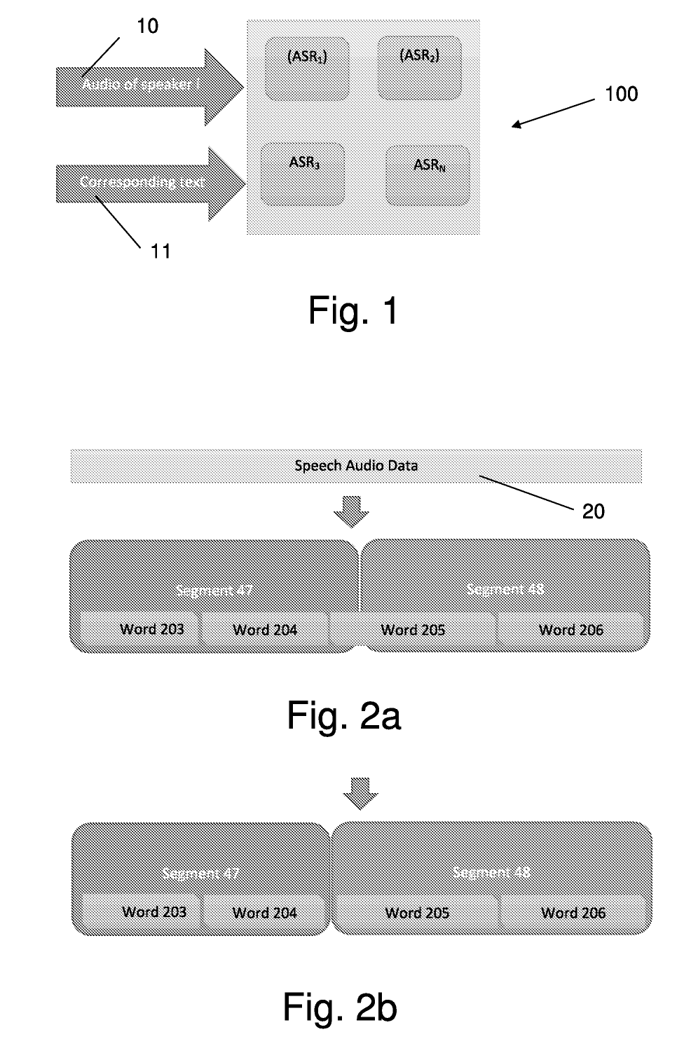

FIG. 1 illustrates the process of training ASR modules the system, according to an embodiment of the invention. In this process, N ASR modules (ASR module₁, . . . , ASR module_{N}) will be trained by system 100 to generate a speech transcription from a received audio signal of a speaker selected from a group of N speakers, such that each audio data 10 of a particular speakerᵢ, (i=1, . . . ,N) that will be received by an ASR module (ASRᵢ) will be used to train a corresponding ASR moduleᵢ, according to a corresponding text 11 that will be concurrently received by ASRᵢ. At the end of the training process, all N ASR modules will be trained.

Each ASR module will have an acoustic model that will be trained. Optionally, each ASR module may also have a linguistic model, which may be trained, as well or may be similar to all N ASR modules.

It should be noted that N should be sufficiently large, in order to represent a large variety of speech styles that are characterized for example, by the speakers attributes, such as gender, age, accent, etc. In addition, it is important to further increase N by selecting several different speakers for each ASR module (for example, if one of the ASR modules represents a 30 years old man with British accent, it is preferable to select several speakers which match that ASR module for the training stage to thereby increase N).

### Transcription Stage:

At the first step of this stage, the system 100 receives an audio or video file that contains speech. In case of a received video file, the system 100 will extract only the speech audio data from the video file, for transcription. At the next stage, the system 100 divides the speech audio data to segments having a typical length of 0.5 to 10 Sec, according to the attributes of the speech audio data. For example, if it is known that there is only one speaker, the segment length will be closer to 10 seconds, since even though the voice of a single speaker may vary during speaking (for example, starting with bass and ending with tenor), the changes will not be rapid.

On the other hand, if there are more speakers (e.g., during a meeting), it is possible that there will be a different speaker each 2-3 Sec. Therefore, a segment length closer to 10 seconds may include 3 different speakers and the chance that there will be an ASR module that will accurately represent all 3 speakers is low. As a result, the segment length should be shortened, so as to increase the probability that only one speaker spoke during the shortened segment. This of course, requires more computational resources but increases the reliability of the transcription, since the chance of identifying alternating speakers increases.

The system 100 will ensure that a word is not cut into two parts during the speech segmentation (i.e., the determination of the beginning and ending boundaries of acoustic units). It is possible to use lexical segmentation methods such as Voice Activity Detection (VAD—a technique used in speech processing in which the presence or absence of human speech is detected), for indicating that a segment ends with a speech signal and that the next segment starts with speech signal immediately after, with no breaks.

FIGS. 2a-2b illustrate the process of eliminating cutting of a word into two parts during speech segmentation, according to an embodiment of the invention. In this example, the speech audio data 20 comprises 4 four words, word 203-word 206. After segmentation into two segments 47 and 48, it appears that word 205 is divided between the two segments, as shown in FIG. 2a. In response, the system 100 checks the location of the majority of the audio data that corresponds to the divided word 205. In this case, most of the audio data of word 205 belongs to segment 48. Therefore, the segmentation is modified such that the entire word 205 will be in segment 48, as shown in FIG. 2b. On the other hand, if most of the audio data of word 205 would have been belong to segment 47, the segmentation would have been modified such that the entire word 205 will be in segment 47.

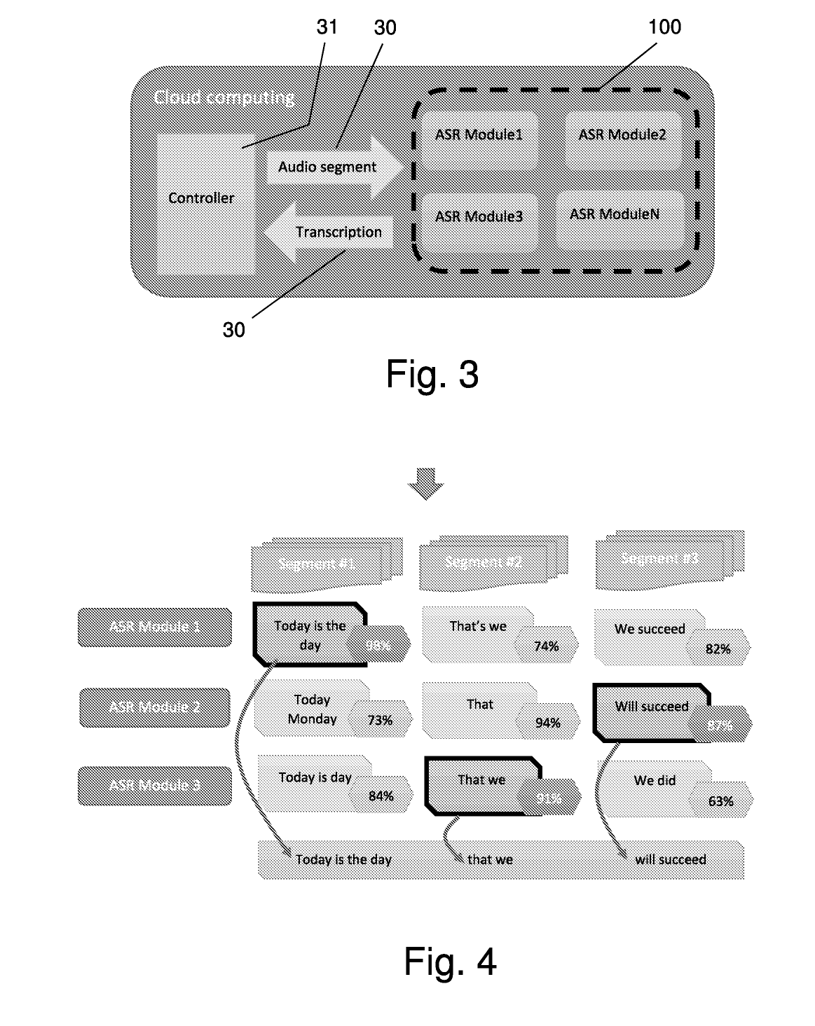

FIG. 3 illustrates the process of generating a transcription of the words in an audio segment, according to an embodiment of the invention. During the transcription stage, each received audio segment 30 is distributed between all N ASR modules by a controller 31. If the system 100 includes a single processor (CPU), controller 31 will distribute the received audio segment 30 to one ASR module at a time. If the system 100 includes multiple processors (CPUs), each processor will contain an ASR module with one acoustic module, representing one ASR module and controller 31 will distribute the received audio segment 30 in parallel to all participating processors. In this case, a system 100 with multiple processors may be a cloud based computational system 32, such as Amazon Elastic Compute Cloud (Amazon EC2—which is a web service that provides resizable compute capacity in the cloud) or Google Compute Module (that delivers virtual machines running in Google's data centers and worldwide fiber network). In case when the received audio segment 30 comprises audio data of several speakers, the controller 31 will make segmentation into shorter segments and the cloud based computational system 32 will match the most adequate ASR module for each shorter segment. After distributing the transcription task to all processors in parallel, controller 31 will retrieve the output of all N ASR modules in parallel, to select and return the optimal transcription 32.

As illustrated in FIG. 3 above, for each audio segment, the system proposed by the present invention N transcriptions received from N ASR modules, where each transcribed segment contains zero or more words. The system now should select the most adequate (optimal) transcription out of the N transcriptions provided. This optimization process includes the following steps:

At the first step, for each word, each ASR module (of an ASR module) returns a “confidence” measure C (C=0%, . . . ,100%) which represents the probability that the given word is correct. At the next step, the system 100 will calculate the average confidence of the transcription for each segment and for each ASR module by getting confidence for each word in the segment and calculating mean of the words' confidence over all N ASR modules. At the next step, the system will decide for each segment what the most accurate transcription is. This may be done in two stages:
Stage 1—choosing only the ASR modules that gave transcription with one of the options below:
“Maximum level 1 words”. For example, if the maximum number of words in a segment was 5, in this stage only the ASR modules that gave a transcription containing 5 words will be chosen.
“Maximum level two words”. For example, if the maximum number of words in a segment was 5, in this stage only the ASR modules that gave a transcription containing 5 words or 4 words will be chosen.

### Stage 2

From all ASR modules in Stage 1 for that segment, only the ASR module whose average confidence is the higher will be chosen. If there are two or more ASR modules with same average confidence, the ASR module that gave a result containing more words will be chosen. If still there are two or more chosen ASR modules, the ASR module with the minimal Standard Deviation (STD) of the confidence of words in the segment will be chosen. At the next step, the system will combine all the decisions made for each segment, to thereby obtain the most accurate transcription of the original speech audio data.

It is possible to identify if there is a single speaker of several speakers by simply providing the number of speakers as an input to system 100. Alternatively, it is possible to use varying time windows method, according to which at the first step a long segment will be selected for analysis. Then at the next step, the selected segment will be divided to two equal sub-segments and submit both sub-segments to all N ASR modules. If for example, one of the ASR modules provides a high level of confidence to one sub-segment and a low level of confidence to the other sub-segment, it is likely that this segment comprises two or more speakers, and therefore, the segment should be shortened. This process is reputed (while further shortening the segment duration) until there will be some similarity between the level of confidence of the two sub-segments.

According to another embodiment, further optimization may be made in order to save computational resources. This is done for a segment number j, by starting the transcription with the previous ASR module i.e., the ASR module that has been selected for segment j−1, Instead of activating all N ASR modules. If the average confidence obtained from the previous ASR module is for example, above 97%, there is no need to transcribe with all N ASR modules, and the system continues to next segment. If after some time the voice of the speaker varies, the level of confidence provided by the previous ASR module will descend. In response, the system 100 will add more and more ASR modules to the analysis, until one of the added ASR modules will increase the level of confidence (to be above a predetermined threshold).

During ongoing segments transcription, it is possible to keep ongoing histograms of the selected ASR modules. If starting the transcription with the previous ASR module is not successful (i.e. the average confidence obtained is less than 97%), transcription may be started with the top 10% in the histogram of the ASR modules selected so far (rather than with all N ASR modules). If the average confidence obtained is still below 97%, the system will continue with the next 10% (below the top 10%) and so on. This way the process of seeking the best ASR module (starting with the ASR modules that were recently in use and that provided higher level of confidence) will be more efficient.

It should be noted that even there is only a single speakerᵢ that trained a particular ASR moduleᵢ, it is not clear that ASR moduleᵢ will always provide the result with the highest confidence. Since the voice of speakerᵢ may vary during a segment or even be different from the voice that used to train ASR moduleᵢ (e.g., due to hoarseness, fatigue or tone variations), it may be more likely that a different ASR module will provide the result with the highest confidence. Therefore, one of the advantages of the present invention is that the system 100 does not determine a-priori which ASR module will be preferable, but allows all ASR modules to provide their confidence measure results and only then, selects the optimal one.

FIG. 4 illustrates the process of obtaining the optimal transcription, according to an embodiment of the invention. In this example, the system 100 includes 3 ASR modules which are used for transcribing an audio signal that was divided into 3 segments, using “Maximum level 1 words” ASR module selection option described above. The speech audio data comprises the sentence: “Today is the day that we will succeed”. In this case, the system divided the received speech audio data into 3 segments, which have been distributed to 3 ASR modules: ASR module1, ASR module2 and ASR module3.

For segment 1, the resulted transcription provided by ASR modules 1 to 3 were “Today is the day” with an average confidence of 98%, “Today Monday” with an average confidence of 73% and “Today is day” with an average confidence of 84%, respectively. For segment 2, the resulted transcription provided by ASR modules 1 to 3 were “That's we” with an average confidence of 74%, “That” with an average confidence of 94% and “That we” with an average confidence of 91%, respectively. For segment 3, the resulted transcription provided by ASR modules 1 to 3 were “We succeed” with an average confidence of 82%, “Will succeed” with an average confidence of 87% and “We did” with an average confidence of 63%, respectively. The system elected the results of 98%, 91% and 87% for segments 1, 2 and 3, respectively and combined them to be the output transcription “Today is the day that we will succeed”. It can be seen that for segment 2, even though ASR module 2 provided an average confidence of 94%, still the system elected (preferred) the result of ASR module 3 (91%<94%), since according to “Maximum level 1 words” option, the number of words to be elected should be 2 (and not 1, like ASR module 2 provided, although with an average confidence of 94%).

### Hardware Implementation

The system proposed by the present invention may be implemented using a computational cloud with N ASR modules, such that each ASR module is run by a different computer among the cloud's resources.

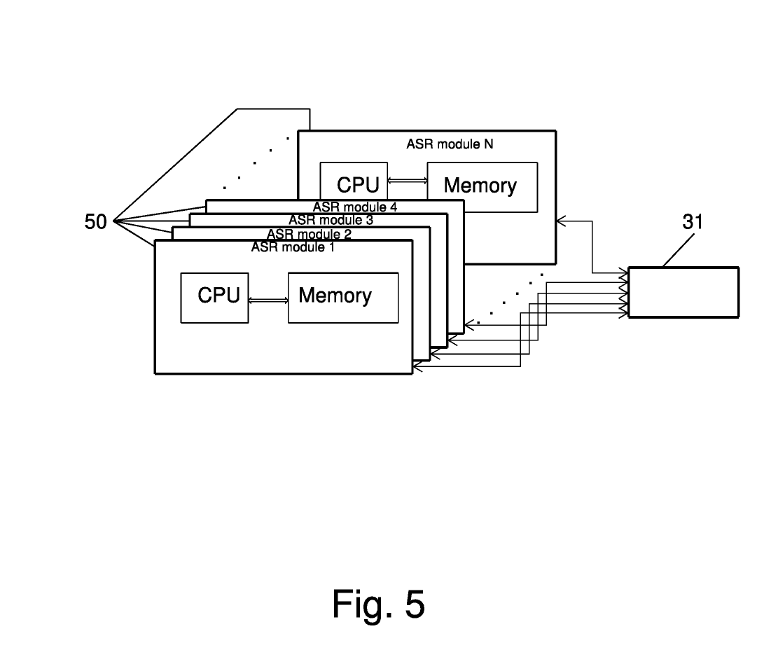

Alternatively, the system may be implemented by a dedicated device with N hardware cards 50 (each card for an ASR module) in the form of a PC card cage (an enclosure into which printed circuit boards or cards are inserted) that mounts all N hardware cards 50 together, as shown in FIG. 5. Each hardware card 50 comprises a CPU 51 and memory 52 implemented in an architecture that is optimized for speech signal processing. A controller 31 is used to control the operation of each hardware card 50 by distributing the speech signal to each one and collecting the segmented transcription results from each one. Each memory card 50 is configured to optimally and rapidly submitting/reading data to/from the CPU 51.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. A method for generating accurate speech transcription from natural speech, comprising:
a) storing in a database, a plurality of audio data items, each of which being recitation of text by a specific speaker;
b) analyzing each audio data item and representing said audio data item by an ASR module, being trained to optimally create a unique acoustic/linguistic model according to the spectral components contained in said audio data item;
c) storing all unique acoustic/linguistic models;
d) receiving natural speech audio signals and dividing each natural speech audio signal to equal segments of a predetermined time;
e) adjusting the length of each segment, such that each segment will contain one or more complete words;
f) distributing said segments to all ASR module and allowing each ASR module to:
f.1) generate a transcription of the words in each segment according to the level of matching to its unique acoustic/linguistic model;
f.2) calculate, for each given word in a segment, a confidence measure being the probability that said given word is correct;
g) for each segment and for each ASR module, calculating the average confidence of the transcription;
h) obtaining the confidence for each word in the segment and calculating mean confidence value of said word;
i) for each segment, deciding what is the most accurate transcription by the following steps:
j) from all chosen ASR modules for said segment, choosing only the ASR module with the highest average confidence; and
k) creating the transcription of said audio signal by combining all transcriptions resulting from the decisions made for each segment.

2. A method according to claim 1, wherein whenever there are more than one ASR module with same average confidence, choosing the ASR module that gave as a result containing more words and if still there is more than one chosen ASR module, choosing the one with the minimal standard deviation of the confidence of the words in the segment.

3. A method according to claim 1, wherein the training is performed according to the following steps:
a) creating N (N≦1) ASR modules of N selected different training speakers; and
b) training each ASR module by an ASR module being an individual ASR module, with speech audio data of a specific training speaker and its corresponding known textual data.

4. A method according to claim 1, wherein the transcription is created according to the following steps:
a) receiving an audio or video file that contains speech;
b) dividing the speech audio data to segments according to attributes of the speech audio data; and
c) whenever a word is divided between two segments, checking the location of the majority of the audio data that corresponds to the divided word and modifying the segmentation such that the entire word will be in the containing said majority;
d) whenever a single processor is used, distributing each received audio segment between all N ASR modules, to one ASR module at a time;
e) whenever the received audio segment comprises audio data of several speakers, performing segmentation into shorter segments and matching the most adequate ASR module for each shorter segment;
f) retrieving the outputs of all N ASR modules in parallel; and
g) selecting and return the optimal transcription among said outputs.

5. A method according to claim 1, wherein the most adequate ASR module is matched for each shorter segment by the following steps:
a) for each word, allowing each ASR module of an ASR module to return a confidence measure representing the probability that the given word is correct;
b) calculate the average confidence of the transcription for each segment and for each ASR module by receiving said confidence measure for each word in the segment and calculating mean confidence value of said words over all N ASR modules;
c) for each segment, decide which transcription is the most accurate by choosing only the ASR modules that gave transcription for which number of words is equal to the maximum number of words in a segment, or smaller than said maximum number of words by 1;
d) from all ASR modules chosen in the preceding step for said segment, choosing only the ASR module whose average confidence is higher;
e) if there are two or more ASR modules with same average confidence, choosing the ASR module that gave a result containing more words;
f) if still there are two or more chosen ASR modules, choosing the ASR module with the minimal Standard Deviation (STD) of the confidence of words in said segment; and
g) obtaining the most accurate transcription by combining all the decisions made for each segment.

6. A method according to claim 5, wherein the transcription of a segment is started with the ASR module that has been selected for its preceding segment.

7. A method according to claim 5, further comprising storing ongoing histograms of the selected ASR modules.

8. A method according to claim 7, wherein the transcription of a segment is started with the ASR modules being at the top in the histogram of the ASR modules selected so far and if the average confidence obtained is still below a predetermined threshold, continuing to the next level below said top and so forth.

9. A method according to claim 1, wherein N is in the order of several dozens or hundreds of speakers.

10. A method according to claim 1, wherein the speech audio data used for training each ASR module is retrieved from one or more of the following sources:
Commercially available or academic databases that include a plurality of speech recordings and their corresponding transcription;
Studio made recordings of training speakers, each of which reading a pre-prepared text;
A database that aggregates and stores audio files of users of mobile devices that read predetermined text.

11. A method according to claim 1, wherein N represents a variety of speech styles that are characterized by:
The gender of a training speaker;
The age of a training speaker;
The accent of a training speaker.

12. A method according to claim 4, wherein length of the segments varies between 0.5 to 10 Sec.

13. A method according to claim 1, wherein multiple processors are activated using a cloud based computational system.

14. Apparatus for generating accurate speech transcription from natural speech, comprising:
a) a data storage for storing a plurality of audio data items, each of which being recitation of text by a specific speaker;
b) a plurality of ASR modules, each of which being trained to optimally create a unique acoustic/linguistic model according to the spectral components contained in said audio data item and analyzing each audio data item and representing said audio data item by an ASR module;
c) a memory for storing all unique acoustic/linguistic models;
d) a controller, adapted to:
d.1) receive natural speech audio signals and divide each natural speech audio signal to equal segments of a predetermined time;
d.2) adjust the length of each segment, such that each segment will contain one or more complete words;
d.3) distribute said segments to all ASR module and activate each ASR module to:
generate a transcription of the words in each segment according to the level of matching to its unique acoustic/linguistic model;
calculate, for each given word in a segment, a confidence measure being the probability that said given word is correct;
d.4) for each segment and for each ASR module, calculate the average confidence of the transcription;
d.5) obtain the confidence for each word in the segment and calculating mean confidence value of said word;
d.6) for each segment, decide which transcription is the most accurate by performing the following steps:
d.7) from all chosen ASR modules for said segment, choose only the ASR module with the highest average confidence; and
d.8) create the transcription of said audio signal by combining all transcriptions resulting from the decisions made for each segment.

15. Apparatus according to claim 14, in which the ASR modules are implemented using a computational cloud, such that each ASR module is run by a different computer among the resources of said cloud.

16. Apparatus according to claim 14, comprising:
a) a dedicated computational device with N hardware cards mounted together, each card implementing an ASR module that includes a CPU and a memory implemented in an architecture that is optimized for speech signal processing; and
b) a controller for controlling the operation of each hardware card by distributing the speech signal to each one and collecting the segmented transcription results from each one. Each memory is configured to optimally and rapidly submitting/reading data to/from said CPU.
